(19) United States
(12) Patent Application Publication
(10) Pub. No.: US 2016/0112982 A1
(43) Pub. Date: Apr. 21, 2016

(54) SYSTEM AND METHOD FOR THE RETENTION OF UNIVERSAL SERIAL BUS AND WIRELESS COMMUNICTION ENABLED DEVICES

(71) Applicant: Michael Babineau, Bow, NH (US)

(72) Inventor: Michael Babineau, Bow, NH (US)

(21) Appl. No.: 14/941,588

(22) Filed: Nov. 14, 2015

Related U.S. Application Data
(63) Continuation of application No. 14/320,605, filed on Jun. 30, 2014.

(51) Int. Cl. H04W 64/00; H04W 76/02; H04W 4/00

(52) U.S. Cl. CPC H04W 64/00; H04W 4/008; H04W 76/023

(57) ABSTRACT

A system and method are provided for substantially preventing the loss of a first electronic device. The system and method establish a short distance wireless communications between the first electronic device and a second electronic device according to a first wireless communications protocol. The second electronic device monitors a signal level strength of the first wireless communication signals between the first electronic device and the second electronic device. The system and method then provide an alert when the signal level strength of the first wireless communication signals falls below a first predetermined short distance communications signal level strength threshold.

### CROSS-REFERENCE TO RELATED APPLICATION

This application is a continuation of U.S. patent application Ser. No. 14/320,605, filed on Jun. 30, 2104, and incorporates such application in its entirety.

### TECHNICAL FIELD

The embodiments described herein relate generally to universal serial bus (USB) and short distance wireless communications enabled electronic devices, and more specifically to systems and methods for protecting from loss the USB—short distance wireless communications electronic devices.

### BACKGROUND

The USB memory storage device—commonly known as a flash drive (FD), thumb drive, USB stick, pen drive, among other names (herein after referred to as “USB/FD”), is for all intents and purposes ubiquitous in its use for storing data. USB flash drives are essentially a combination of the highly successful memory storage device known as flash memory, developed by Toshiba in the early 1980's, and the universal serial bus (USB), which has become the standard for interconnections between external devices that are used with computers. A detailed discussion of the technology is not necessary for understanding the principles of the embodiments described herein, and thus has been omitted in fulfillment of the dual purposes of clarity and brevity.

As discussed above, USB flash drives have practically replaced most other types of external data mass storage devices, except in some special circumstances. For example, digital video disks are still a common means of storing video, especially commercially produced movies. But more and more people rely on the USB flash drive to copy, store, and transfer computer files, digital photos, and other electronic data, when in the past, that same electronic data (whatever its form) might have been stored on floppy disks, compact disk read only memory disks (CD-ROMs), among other types of memory storage devices. Thus, many people will store their electronic documents, files, photos, and other digital media on a USB flash drive as a very convenient method of transporting large amounts of electronic data without having to transmit it via electronic mail (email), or other electronic communications systems that might be less than secure and/or reliable. Thus, doctors can store patient's data from their personal computers to take to a clinic, or the hospital, or may retain data created by medical equipment so that they can study it in their office at a more convenient, quiet time, and so on. Other professionals, such as artists, musicians, teachers, students, attorneys, architects, advertising and marketing professionals, among many other types of professionals, will use USB flash drives for essentially the same purposes. And, as all of these people could probably readily agree, the loss of even a single USB flash drive that can hold gigabytes, or even a terabyte of data, could be, if not would be, catastrophic. While extremely useful and convenient, however, there is a problem inherent to their compact size: USB flash drives are very easy to misplace, lose, or inadvertently leave behind. The USB/FD devices can easily be lost on the clutter of a desk or drawer.

Thus, retaining (i.e., not losing) a USB flash drive is something many people worry about, and have attempted to alleviate. Most, if not all of the prior art apparatus that attempt to prevent loss of USB flash drives, however, merely provide reminders in an attempt to keep the users from losing or misplacing their devices. The detrimental effect of losing a USB-enabled device is not limited, however, to external storage FD devices; other USB enabled devices exist (speakers, headsets, among other devices), and their loss can be justly as costly and/or inconvenient.

For example, U.S. Published Patent Application No. 2011/0210860 by Kuo, provides an alarm control circuitry for a universal serial bus port connectable device including an alarm generator emitting an audible alarm when powered by internal voltage from a capacitor charged by external voltage from a computer during connection of the device to a computer and actuated with a power off detection circuit in the condition that termination of power from the computer to the device is detected. Provision is made for an optional base unit with passive radio frequency identification (RFID) in the alarm control circuitry that includes an RF transceiver, ID reader, timer and counter which allegedly causes an alarm activation if a ‘reflected’ RF signal is not received in a certain amount of time. An exemplary power off detection circuit outputs an alarm control signal digital logic ‘1’ in alarm generator actuation using an AND gate fed by internal voltage and external voltage reverse logic.

In addition, U.S. Published Patent Application No. 2013/0007472, by Yamada, provides an electronic device that causes a removable storage medium to store data, the electronic device further including a removable storage medium, a storage medium interface connecting to the storage medium, and a control unit allegedly configured to generate an encryption key at a predetermined time. The control unit further encrypts data to be stored in the storage medium using the encryption key, stores encrypted data in the storage medium, and allegedly stores the encryption key in the storage medium in association with the encrypted data, if it is detected that the storage medium has been removed by a user.

Further still, U.S. Published Patent Application No. 2013/0257604 by Mirle, et al., provides a vehicle system for determining that at least one mobile electronic device is generally stationary and is potentially forgotten. The system includes a vehicle data bus and a control module. The vehicle data bus transmits a signal indicating at least one trigger event. The trigger event indicates a vehicle exit condition. The control module is in communication with the mobile electronic device and the vehicle bus. The control module is in communication with the mobile device through a data connection to receive information. The control module includes control logic for receiving the trigger signal from the vehicle data bus. The control module includes control logic for determining if the mobile electronic device has moved based on information received from the data connection. The control module includes control logic for determining if the mobile electronic device is generally stationary if the trigger signal is received.

There are certain problems, however, with the prior art systems and methods that allegedly prevent loss of the USB flash drive devices. Accordingly, it would be desirable to provide methods, modes and systems for substantially preventing the loss of USB flash drive devices.

### SUMMARY

An object of the embodiments is to substantially solve at least the problems and/or disadvantages discussed above, and to provide at least one or more of the advantages described below.

It is therefore a general aspect of the embodiments to provide methods, modes and systems for substantially preventing the loss of USB-enabled devices that will obviate or minimize problems of the type previously described. According to a first aspect of the embodiments, a method for substantially preventing the loss of a first electronic device is provided comprising establishing short distance wireless communications between the first electronic device and a second electronic device according to a first wireless communications protocol, monitoring a signal level strength of the first wireless communication signals between the first electronic device and the second electronic device, and providing an alert when the signal level strength of the first wireless communication signals falls below a first predetermined short distance communications signal level strength threshold.

According to the first aspect of the embodiments, the step of establishing first wireless communications comprises downloading a first device position monitoring application on the second electronic device, and configuring the first device position monitoring application on the second electronic device to recognize the first electronic device according to the first wireless communications protocols. According to the first aspect of the embodiments, the step of configuring comprises using as the first wireless communications protocol a Bluetooth (BT) wireless communications protocol, and performing a pairing procedure between the first electronic device and the second electronic device according to BT pairing procedures.

Still further according to the first aspect of the embodiments, the step of configuring comprises selecting an alert procedure to inform a user of the second electronic device when the signal level strength of the short distance wireless communication signal falls below the first predetermined short distance communications signal level strength threshold, and wherein the step of selecting an alert procedure comprises selecting one or more of an alert graphic, an alert audible tone, enablement of a vibration to occur, a phone call notification, an email notification, and a texting notification.

According to the first aspect of the embodiments, the step of monitoring comprises comparing the signal level strength of a received first wireless communication signal with a first predetermined signal level strength threshold, such that when the received signal level strength of the first wireless communication signals falls below the first predetermined signal level strength threshold, that a position condition of the first electronic device relative to the second electronic device has changed from a normal condition to a left-behind condition. According to the first aspect of the embodiments, the left-behind condition comprises a first percentage of a maximum distance of communications when using the first wireless communications protocols, and wherein the first percentage of the maximum distance can be any percentage between about 0% to about 100% of the maximum distance of communications when using the first wireless communications protocol. Still further according to the first aspect of the embodiments, the first wireless communications protocol is a Bluetooth (BT) wireless communication system protocol, and the maximum distance is based on a class classification of the first electronic device, and wherein the first device is a universal serial bus (USB) flash drive (FD) memory storage device with a BT transceiver, and further wherein the BT transceiver receives its power from a USB power connection. According to the first aspect of the embodiments, the first device can be one of a BT enabled speaker apparatus, and headset.

According to a second aspect of the embodiments, a system for substantially preventing the loss of a first electronic device is provided, wherein the first electronic device includes a first wireless communications transceiver, and the system comprises a second electronic device that includes a processor, memory, and a first wireless communications transceiver, and wherein the second electronic device is configured to communicate with the first electronic device according to a first wireless communications protocol, and wherein the second electronic device is further configured to monitor a signal level strength of the first wireless communication signals from the first electronic device, and further wherein the second electronic is configured to provide an alert when the signal strength of the first wireless communication signals falls below a first predetermined short distance communications signal level strength threshold.

According to the second aspect of the embodiments, the first wireless communications protocol is one of a Bluetooth, near field communications and Wi-Fi communications protocol, and the second electronic device has stored in a memory therein a first device position monitoring application and further wherein the first device position monitoring application on the second electronic device is configured to recognize the first electronic device according to the first wireless communications protocols. According to the second aspect of the embodiments, the first electronic device comprises a Bluetooth (BT) communications transceiver powered by interconnection with a third electronic device, and wherein the interconnection is a universal serial bus interconnection (USB), and wherein the first wireless communications protocols is a Bluetooth communications protocol, and the second device is configured to perform a pairing procedure between the first electronic device and the second electronic device according to Bluetooth pairing procedures.

According to the second aspect of the embodiments, the first device position monitoring application is configured to generate an alert to inform a user of the first and second electronic device when the signal level strength of the short distance wireless communication signal falls below the first predetermined short distance communications signal level strength threshold, and wherein the alert in the second electronic device comprises one or more of a graphic, audible tone, vibration, phone call notification, email notification, and texting notification.

According to the second aspect of the embodiments, the second electronic device is configured to compare the signal level strength of a received first wireless communication signal with a first predetermined signal level strength threshold, such that when the received signal level strength of the first wireless communication signal falls below the first predetermined signal level strength threshold, that a position condition of the first electronic device relative to the second electronic device has changed from a normal condition to a left-behind condition.

Still further according to the second aspect of the embodiments, the left-behind condition comprises a first percentage of a maximum distance of communications when using the first wireless communications protocols, and wherein the first distance wireless communications protocol is a Bluetooth (BT) wireless communication system protocol, and the maximum distance is based on a classification of the first electronic device, and wherein the first percentage can be any percentage between about 0% to about 100% of the maximum distance of communications when using the BT wireless communication system protocol according to the classification of the first electronic device.

According to the second aspect of the embodiments, the first device is a universal serial bus (USB) flash drive (FD) memory storage device with a BT transceiver, and further wherein the BT transceiver receives its power from a USB power connection, and the first device can be one of a BT enabled speaker apparatus, and a headset.

### BRIEF DESCRIPTION OF THE DRAWINGS

The above and other objects and features of the embodiments will become apparent and more readily appreciated from the following description of the embodiments with reference to the following figures, wherein like reference numerals refer to like parts throughout the various figures unless otherwise specified, and wherein:

FIG. 1 is a block diagram depicting a universal serial bus/electronic drive/Bluetooth (USB/EFD/BT) device connected to a computer device with a Left-Behind application (App) stored on a mobile electronic device configured to warn a user in the event that the USB/ED/BT device becomes separated from the mobile electronic device by a distance greater than a first distance threshold according to an embodiment;

FIG. 2 illustrates a method of using the Left-behind App and USB/ED/BT device according to an embodiment;

FIGS. 3A, 3B, 3C and 3D illustrates several physical configurations of the USB/ED/BT device that indicate conditions ranging from a “normal” state to a “left-behind” state according to an embodiment;

FIG. 4 illustrates a functional block diagram of the computer device shown in FIG. 1 with which USB/ED/BT device, mobile electronic device, and the Left-behind App can be implemented according to an embodiment;

FIGS. 5, 6, 7, 8, 9, 10, 11, 12A, 12B, 13, 14A and 14B illustrate a plurality of screen shots of one or more electronic devices upon which the Left-behind App 114 described in reference to FIG. 2 has been installed, showing several examples of graphical user interfaces (GUIs) for such situations a main screen, configuration, graphics selection, and several other configuration and use GUIs, according to different aspects of the embodiments; and

FIG. 15 illustrates a method of downloading and setting up Left-behind App on the mobile electronic device according to an embodiment.

### DETAILED DESCRIPTION

The embodiments are described more fully hereinafter with reference to the accompanying drawings, in which embodiments of the inventive concept are shown. In the drawings, the size and relative sizes of layers and regions may be exaggerated for clarity Like numbers refer to like elements throughout. The embodiments may, however, be embodied in many different forms and should not be construed as limited to the embodiments set forth herein. Rather, these embodiments are provided so that this disclosure will be thorough and complete, and will fully convey the scope of the concept to those skilled in the art. The scope of the embodiments is therefore defined by the appended claims. The following embodiments are discussed, for simplicity, with regard to the terminology and structure of a 4G/LTE so-called “smart phone” and USB/FD memory storage device. However, the embodiments to be discussed next are not limited to these systems but may be applied to other electronic devices with BT communications capability that can be lost or misplaced.

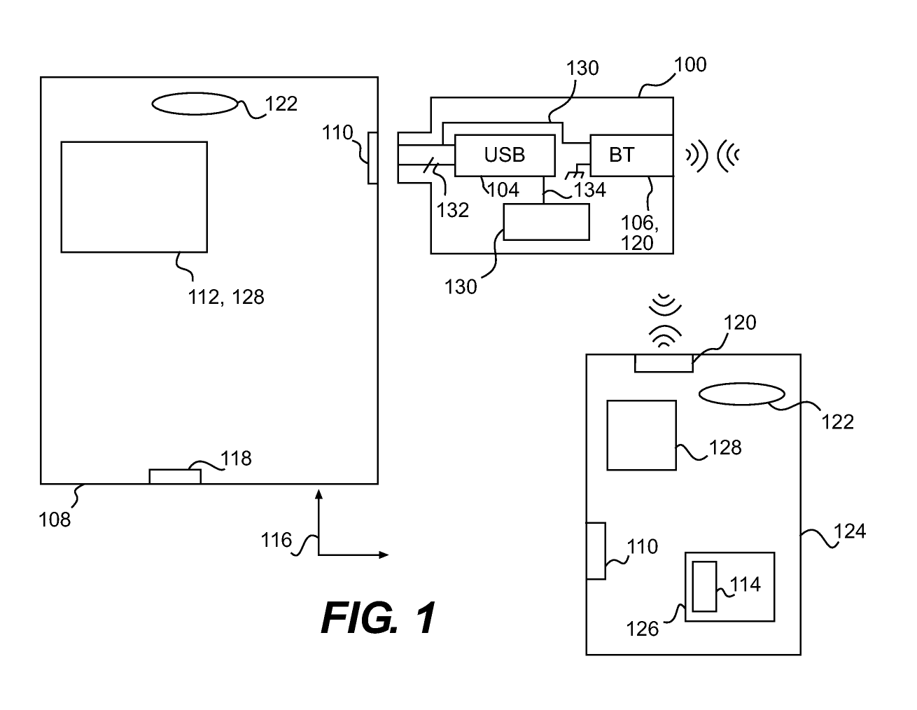

FIG. 1 is a block diagram depicting USB/ED/BT device 100 connected to computer device 108 with Left-behind App 114 stored on mobile electronic device 124 configured to warn a user in the event that USB/ED/BT device 100 becomes separated from mobile electronic device 124 by a distance greater than a first distance threshold according to an embodiment. As shown in FIG. 1, USB/ED/BT device 100 contains USB circuitry 104, other electronic device circuitry 136, USB data/logic lines 132 (which connect between computer device 108 and USB circuitry 104) and Bluetooth (BT) circuitry 106. A detailed discussion regarding the operation of other electronic device circuitry 136 is not necessary to understand the different aspects of the embodiments, and so in fulfillment of the dual purposes of clarity and brevity, the details of which have been omitted. Other electronic device circuitry 136 is connected to USB circuitry 104 via bus 134, and can generally comprises at least one of a flash drive memory, headset, or speaker devices.

As those of skill in the art can appreciate, one of the innovate aspects of USB circuitry 104 when it was introduced was that it received or could receive power directly from the device that it was connected to, thereby enabling the incredibly high speeds of data transfer. This made it a natural companion to external memory storage devices, including, among others, flash drive storage devices. An additional reason that it worked well with flash drive memory storage is that the USB connection provides voltage to not only USB circuitry 104, but this voltage can be used in the flash drive circuitry, which creates the charge that stores the data for very long periods of time in the floating gate of the metal oxide semiconductor field effect transistor (MOSFET) in the flash drive circuitry. Thus, according to an embodiment, USB power 130 is connected not only to USB circuitry 104 but also BT circuitry 106 (which includes BT transceiver 120; from hereon in, the BT apparatus will be simply referred to as BT transceiver 120, and this incorporates BT circuitry 106).

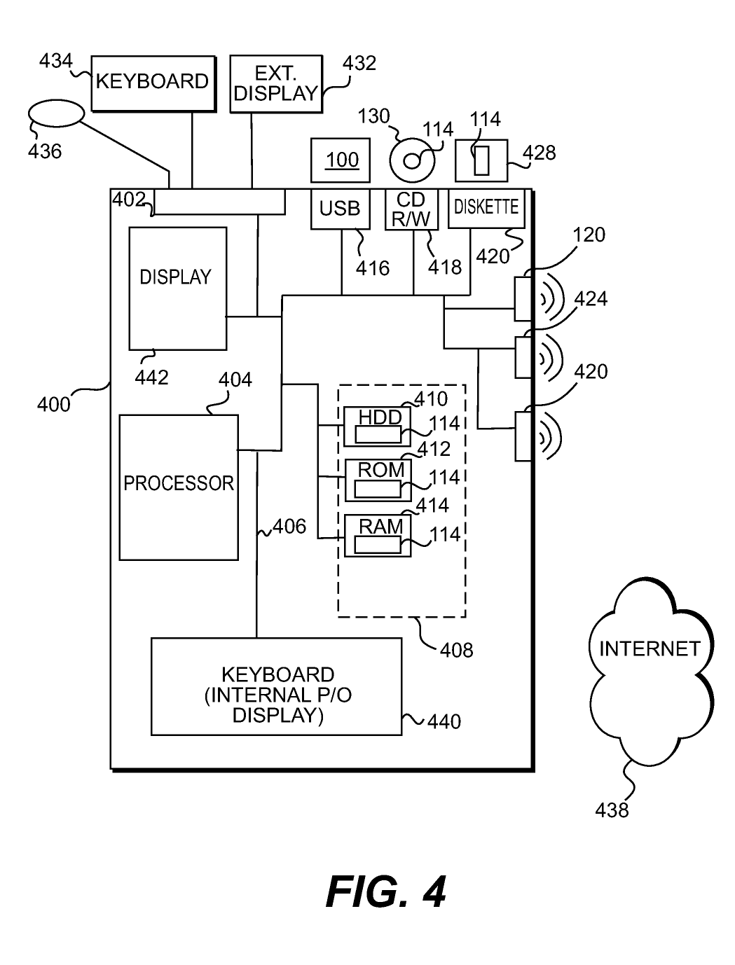

Computer device 108, described in greater detail below in regard to FIG. 4, contains one or more processors, memory and other internal circuitry (not shown in FIG. 1), necessary for proper operation thereof, depending on the type of device that computer device 108 is; that is, according to embodiments, computer device 108 can be a personal computer (PC), laptop, personal digital assistant (PDA), tablet, printer, video players (digital video disk and blue ray players, among others) game boxes, among many other types of electronic devices that have a USB port.

According to an embodiment, mobile electronic device 124 contains Bluetooth communications circuitry, including BT transceiver 120 as shown, or a near-field communications (NFC) transceiver (not shown in FIG. 1, but shown in FIG. 4; for purposes of this discussion, any type of bi-directional wireless communications apparatus can accommodate the principles of the aspects of the embodiments described herein; but, in fulfillment of the dual purposes of clarity and brevity, discussion will only be made to the Bluetooth mode of short distance communications capabilities; such discussion shall not be construed in a limiting sense as many different types of short distance communications systems are encompassed in the different aspects of the embodiments). Also shown in FIG. 1 as part of computing device 108 is wired communications link/cables 116 and wireless communications link 118, and speaker 122. Similarly, mobile electronic device (MED) 124 also contains BT transceiver, 120, speaker 122, memory 126 (wherein is stored Left-behind App 114), USB receptacle 110, and MED display/interface 128. As those of skill in the art can appreciate, MEDs 124, which according to aspects of the embodiments are smart phones and/or tablets, generally have an interactive touch screen display, but that not necessarily need be the case, as older style 3G phones can also download applications, have BT transceivers 110, and have button keyboards for entering data. Left-behind App 114 is stored in one or more types of memory 126, the details of which are discussed in greater detail below in regard to FIG. 4.

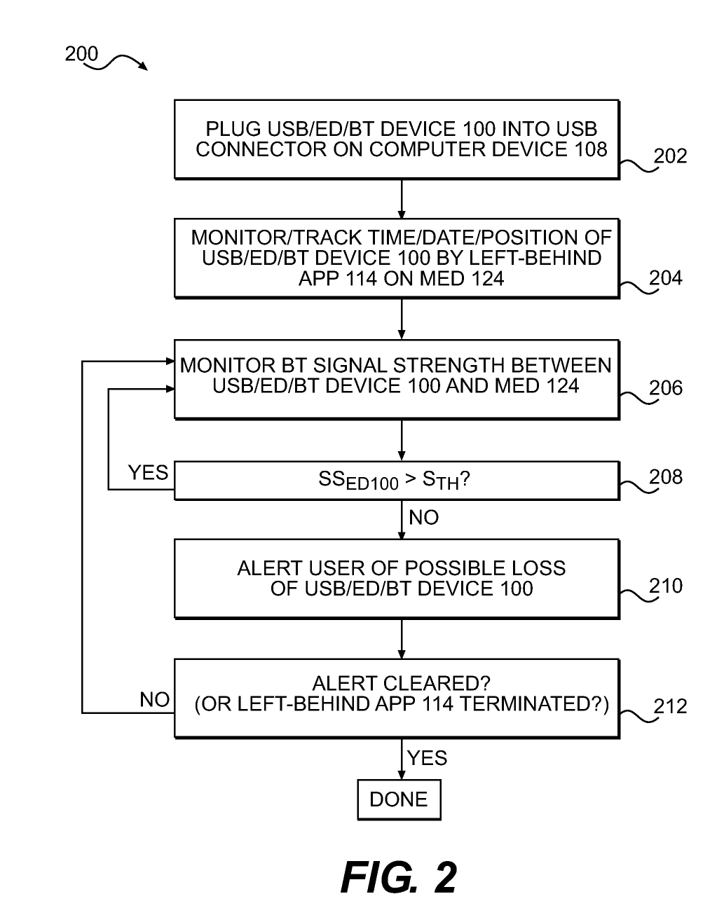

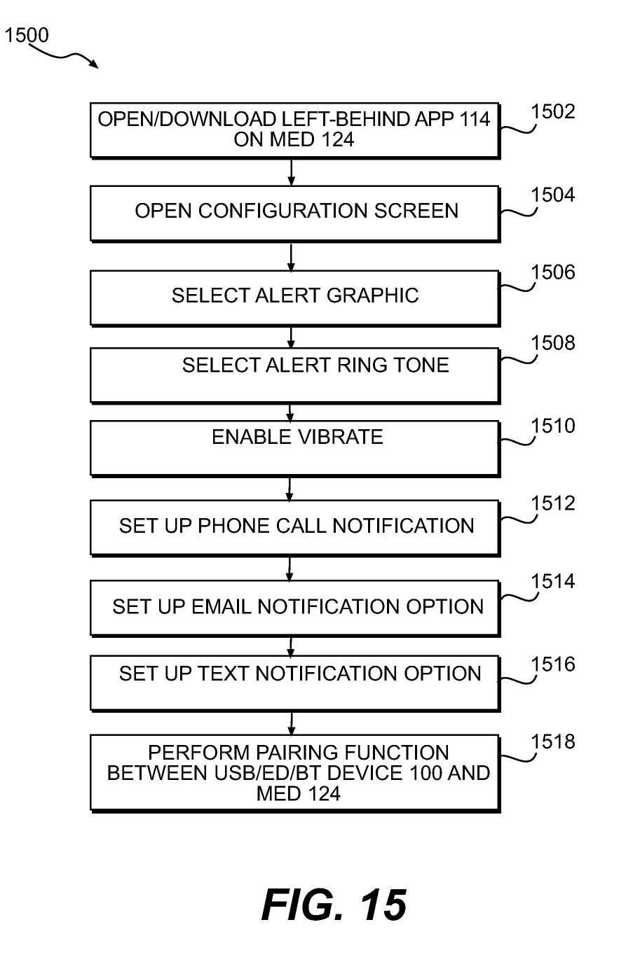

According to an embodiment, and as shown in FIG. 1, BT circuitry 106 receives its power directly from the same power line connection that is used to power USB/ED circuitry 104, 136. This allows BT transceiver 120 of USB/ED/BT device 100 to have the capability of constantly transmitting identification signals that can be received by BT transceiver 120 of MED 108 and processed therein, following downloading of Left-behind App 114, and performing at least the pairing process of the configuration process shown in FIG. 15. Processing of USB/ED/BT 100 BT signals in conjunction with Left-behind App 114 on MED 124 is described in greater detail in regard to FIG. 2.

As briefly described above, MED 124 contains Left-behind App 114, stored in one or more different types of memory (discussed in greater detail below in regard to FIG. 4), which causes MED 124 to constantly monitor a BT signal emitted from USB/ED/BT device 100 according to an embodiment. Left-behind App 114 can also cause an indication of loss of signal to be made when USB/ED/BT device 100 exceeds a first distance threshold, d_{TH}, according to an embodiment. That is, Left-behind App 114 constantly monitors the Bluetooth signal from USB/ED/BT device 100 and as long as the signal strength remains above a certain threshold, indicating that it is within a certain distance, d_{TH}, then Left-behind App 114 ascertains that USB/ED/BT device 100 is within that certain distance and is not being “left-behind” i.e., being forgotten or lost. At this point, it is useful to define certain naming conventions and variables. The distance between USB/ED/BT device 100 and MED 124 is referred to as Δd; the distance threshold at which an alarm or warning will be instituted is referred to as d_{TH}; the BT signal strength threshold at the distance threshold is SS_{TH}; and the measured BT signal strength from USB/ED/BT device 100 is SS_{ED100}.

If, however, the signal strength falls below a certain level (either from being a certain distance away (e.g., Δd>d_{TH})) or from loss of power to USB/ED/BT device 100, Left-behind App 114 will immediately interrupt the processor of MED 124 and cause in indication that USB/ED/BT device 100 is in danger of being lost, mislaid, or left-behind. This indication can be in the form of a vibration of MED 124, a flashing display, aural display, a tweet or text to a different registered electronic device such as a cell phone, or an email to a registered email account, among other types of indicators. A detailed discussion of the indicators made when connection between MED 124 and USB/ED/BT device 100 is lost or is in immediate danger of being lost is described below in greater detail in regard to FIG. 2.

FIG. 2 illustrates a flow diagram of method 200 for use of Left-behind App 114, MED 124, and USB/ED/BT device 100 according to an embodiment. An encoding process is discussed with reference to FIG. 2. This encoding process is not meant to limit the embodiments, nor to suggest that any particular embodiment should be implemented following this encoding process. The purpose of the following encoding process is to facilitate the understanding of an embodiment and to provide the reader with one of many possible implementations of the processes discussed above. FIG. 2 shows a flow chart illustrating various steps performed during the encoding process. The steps shown in FIG. 2 are not intended to completely describe the encoding process but only to illustrate some of the aspects discussed above, nor should they be construed to indicate that any particular order of steps needs to occur, unless otherwise so indicated.

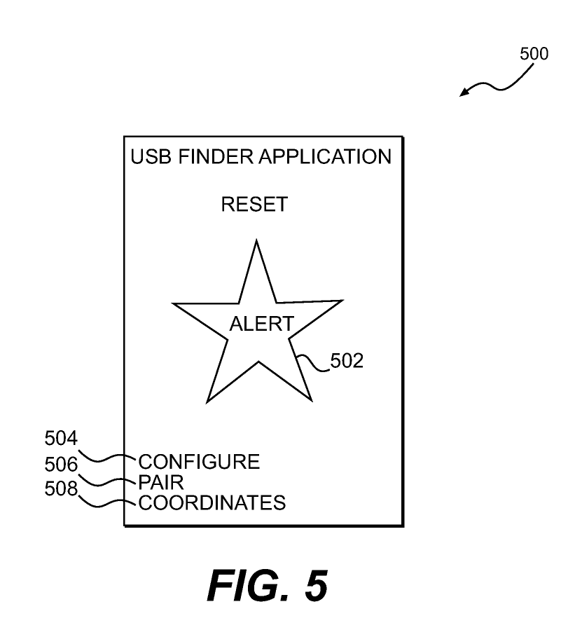

Method 200, as those of skill in the art can appreciate, presumes that a user has already downloaded Left-behind App 114 onto MED 124, and at least performed a pairing process between MED 124 and USB/ED/BT 100 according to an embodiment. The downloading, pairing, and other processes associated thereto are described below in greater detail in regard to FIG. 15. FIGS. 5-14 illustrate a plurality of GUIs that a user would encounter during set-up and use of Left-behind App 114 on MED 124, and FIG. 15 illustrates a flowchart of method 1500 for installation and setup of Left-behind App 114. As those of skill in the art can appreciate, there are many different ways to install an App; it can be done wirelessly, via a cell-phone service connection, through a local Wi-Fi network, via the internet, and from a hard copy on a data storage device, among other means. Following installation and at least pairing, a user can begin to use Left-behind App 114 with the USB/ED/BT device 100 that has been paired with MED 124, according to method 200 as described in regard to FIG. 2.

Method 200 begins with step 202, wherein the user inserts either a previously paired USB/FD/BT device 100 into computer device 108 at USB receptacle 110, which mates with USB connector 102, or one in which the user will soon thereafter perform the pairing process between the inserted USB/ED/BT device 100 and MED 124. According to embodiments, it does not matter what type of device computer device 108 is—that is, it can be a pc, laptop, a tablet, printer, or any other device that includes a USB interface. The “pairing” process of BT devices is well known to those of skill in the art; in a simplified summary the process ensures that MED 124 has the unique identifier of USB/EFD/BT device 100, and that it can communicate wirelessly through conventional BT communication protocols and techniques. Following insertion (and pairing if not previously done), MED 124 and Left-behind App 114 will begin to monitor/track USB/ED/BT device 100 as shown in method step 204. As those of skill in the art can appreciate, if method 1500 has already taken place, as described in greater detail below, then pairing as described in method step 204 does not need to, and would not, take place again.

In method step 204, method 200 can optionally track one or more of a time/date/position of use of USB/ED/BT device 100. It may be the case that the user will have lost USB/ED/BT device 100 and not recognized the fact, in spite of the indicators that Left-behind App 114 can provide in the event of potential loss of USB/ED/BT device 100. Or, it could be that a different user not aware of the capabilities of Left-behind App 114 is using MED 124, or for different reasons, it might be important to know where and when USB/ED/BT device 100 was last used with computer device 108; in this case, optional method step 204 tracks one or more of a time/date/position of usage. Such positional information can be ascertained from a global positioning signal, cellular service triangulation methods, or other methods, all of which are known to those of skill in the art and thus a detailed description thereof is both unnecessary and beyond the scope of this discussion and so in fulfillment of the dual purposes of clarity and brevity, have been omitted. The positioning determining methods, whichever might be available, can help ascertain where USB/ED/BT device 100 might have last been used. As those of skill in the art can readily appreciate, such tracking of time/date/position could be beneficial to the user to help ascertain the last location USB/ED/BT device 100 was used. Further, the embodiments described herein in reference to tracking and notifying in the event of possible loss of USB/ED/BT device 100 can be extended to many other self-powered items including, but not limited to, other phones or electronic devices, car key fobs, among other items. The position information can further include geographic coordinates information, such as latitude and longitude.

In method step 206, method 200 begins active monitoring of USB/ED/BT device 100. Left-behind App 114 periodically communicates to USB/ED/BT device 100 to ensure that it is within first threshold distance d_{TH}. According to embodiments, d_{TH} can be set to a first percentage of the maximum distance of BT communications dependent upon the class of Bluetooth USB/ED/BT device 100 is capable of using; that is, according to an embodiment, the range can be set by the user, but is subject to the constraints of the BT communications capability inherent in the manner in which the providers of the BT protocols have established as a maximum range of BT communications. According to further embodiments, there are three classifications of BT communications ranges, which are dependent upon transmitter power and other factors. Class 1 has a range of about 100 meters; class 2 a range of about 10 meters, and class 3 a range of about 1 meter (see, http://www.bluetooth.com/Pages/Bluetooth-Home.aspx and http://en.wikipedia.org/wiki/Bluetooth). According to further embodiments, and to be understood that this particular embodiment is not to be taken in a limiting manner, USB/FD/BT device 100 can be configured as a class 2 BT device, and thus d_{TH} can be set to be about 10 meters, which is about thirty (30) feet or so. According to still further embodiments, the first percentage can be any percentage between 0% and 100%, and according to still further aspects of the embodiments can be between 50% and 100% of the maximum communications range according to the class of BT device. That is, if USB/ED/BT device 100 is a class 2 BT device, such that a maximum communications range is about 10 meters, and the user sets the first percentage to be 90%, then when USB/FD/BT device 100 is about 9 meters from electronic device 100, the signal strength will fall below the calculated signal strength threshold, SS_{TH}, that Left-behind App 114 determines according to known signal strength values of BT communications' protocols, and the aforementioned first percentage value input by the user.

Following step 206, method 200 proceeds to decision step 208. In decision step 208, method 200 substantially continuously verifies that the signal strength transmitted by USB/EFD/BT device 100, SS_{ED100} is greater than or equal to a predetermined BT signal threshold, S_{TH}. That is, method 200 ascertains whether—

SS_{ED100}≧S_{TH} (1).

As long as there is signal strength from USB/ED/BT device 100 and it exceeds the signal strength threshold, then method 200 substantially continuously monitors the BT signal from USB/EFD/BT device 100 (“Yes” path from decision step 208), and nothing changes in regard to Left-behind App 114. Method 200 then returns to steps 206 and 208, and substantially continuously monitors the BT signal strength from USB/ED/BT 100.

If, however, the signal strength from USB/EFD/BT device 100 falls below the signal strength threshold (“No” path from decision step 208), method 200 proceeds to step 210. In step 210, method 200 (Left-behind App 114) alerts the user that USB/ED/BT device 100 is in danger of being left behind, or lost, or misplaced.

According to further embodiments, Left-behind App 114 can alert the user that USB/ED/BT device 100 is in danger of being left behind by causing to be displayed an indication of some sort. Left-behind App 114 can also cause MED 124 to vibrate, or cause a sound to be emitted from speaker 122 (the tone or nature of which can be user selectable, as known to those of skill in the art and the selections of “ring-tones”). Left-behind App 114 can also cause an electronic indication be made, such as a text, tweet, email, phone call, or other means of electronic communications, to be sent to a pre-determined email address, phone number, among other electronic communication means, as appropriate. Furthermore, Left-behind App 114 can continuously monitor a time/date/location of MED 124, to the extent that such information is available, and has been selectable configured as such, so that in the electronic communication detailed information can be provided to the user.

Method 200 then proceeds to decision step 212 wherein method 200 determines if an “Alert Clear” box has been checked; this allows the user to terminate the left-behind indicator, in whatever form it may be. Decision step 212 also determines if Left-behind App 114 has itself been terminated (in the event of MED 124 being powered down), and causes the electronic indicator to cease. Left-behind App 114 will attempt to maintain its database in that latter condition, of the time/date/location information and re-send such electronic communication in the future. If the alert has not been cleared (“No” path from decision step 212), method 200 returns to step 206, and continues to monitor the BT signal strength of USB/ED/BT device 100 according to an embodiment. It is possible that the user could move in and out range with regard to the BT signal detection threshold, and if the user were to go back for the USB/ED/BT device 100, there is little reason to keep sounding an alarm condition.

According to an embodiment, multiple electronic communications can be sent, but generally most users will want that only one communication be sent, and thus Left-behind App 114 is set up to perform in that manner. According to a further embodiment, the visual/aural/vibratory alerts can continue, for a certain pre-determined period of time, or until cleared or MED 124 powered down.

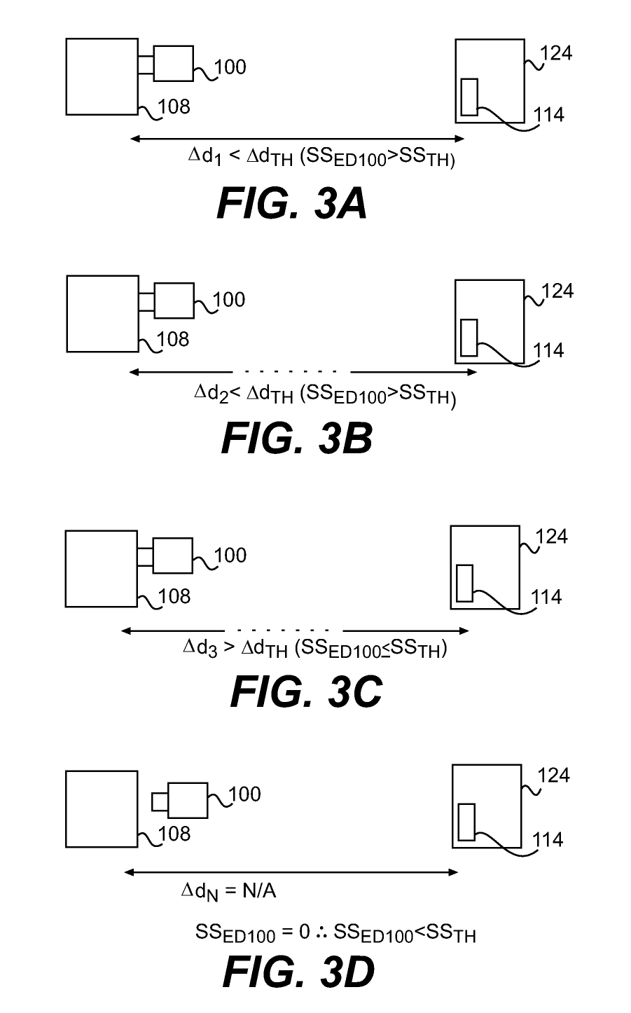

FIGS. 3A-3D illustrate several physical configurations of USB/ED/BT device 100 in regard to MED 124 in a “Normal,” “OK,” and “Left-behind” state according to an embodiment. In FIG. 3A, USB/ED/BT device 100 is attached to computer device 108; presuming that USB/ED/BT device 100 has been “paired” with MED 124, and computer device 108 is powered, Left-behind App 114 within MED 124 will be establishing or has established communications with the BT circuitry located within USB/ED/BT device 100 and is monitoring its location. The distance between USB/EFD/BT device 100 and MED 124, Δd₁ is less than d_{TH}, meaning that the BT signal strength of USB/ED/BT device 100 as received by MED 124, SS_{ED100}, is greater that the BT signal strength threshold, SS_{TH}. This is an “normal” state, and indicates that USB/ED/BT 100 is not considered to be in danger of being left behind or lost. Should, however, USB/ED/BT device 100 become unattached from computer device 108, as shown in FIG. 3D, then regardless of the distance between USB/ED/BT device 100 and MED 124 Δd, Left-behind App 114 will cause an alarm according to how it has been setup or configured because the received and monitored BT signal strength, SS_{ED100}, has now substantially immediately fallen below the signal level threshold for issuing an alarm condition, SS_{TH}.

In FIG. 3B, the distance between USB/ED/BT device 100, Δd₂, has increased (Δd₂>Δd₁), but still Δd₂ is less than Δd_{TH}. Consequently, the received and monitored BT signal strength from USB/ED/BT device 100, SS_{ED100}, is still larger than the signal strength threshold SS_{TH} below which indicates an alarm condition. FIG. 3B, similarly to FIG. 3A, represents an “Ok” condition.

In FIG. 3C, however, Δd₃ is now greater than Δd_{TH} (Δd₃>Δd_{TH}), and this represents the “Left-behind” condition. The “Left-behind” condition of FIG. 3C represents steps 208-212 of method 200, presuming that first the predetermined alert is made, and then cleared.

FIGS. 5-13 illustrate a plurality of screen shots of one or more MEDs 124 upon which Left-behind App 114 described in reference to FIG. 2 has been installed, showing several examples of graphical user interfaces (GUIs) for situations such as a main screen, configuration, graphics selection, and several other configuration and use GUIs, according to different aspects of the embodiments. In addition, FIG. 15 illustrates a flow chart of method 1500 for configuring Left-behind App 114 and MED 124 to work together to substantially prevent loss of USB/ED/BT device 100, according to an embodiment.

FIG. 5 illustrates Left-behind App 114 main screen 500 according to an embodiment. Main screen 500 is the GUI that is presented to a user of Left-behind App 114 upon downloading/purchase of Left-behind App 114, and when an alert condition is detected. Alert Button 502 can be in the form of a star, as shown or some other user selectable icon. To reset an alert condition, a user would simply tap Alert Icon 502. Left-behind App 114 then goes into a sleep state until it detects that USB/ED/BT device 100 is being used again. Tapping Configure Button 504 allows the user to set the alert features at any time, not just upon a “set-up” condition when first downloaded and/or used. Tapping Pair Button 508 performs the “pairing” action, discussed above, that connects USB/ED/BT device 100 to Left-behind App 114 and the device it is located or stored on. Tapping Coordinates Button 508 launches a specific search feature of Left-behind App 114 that helps the user find a lost USB/ED/BT device 100, according to an embodiment. Each of these will be discussed in turn.

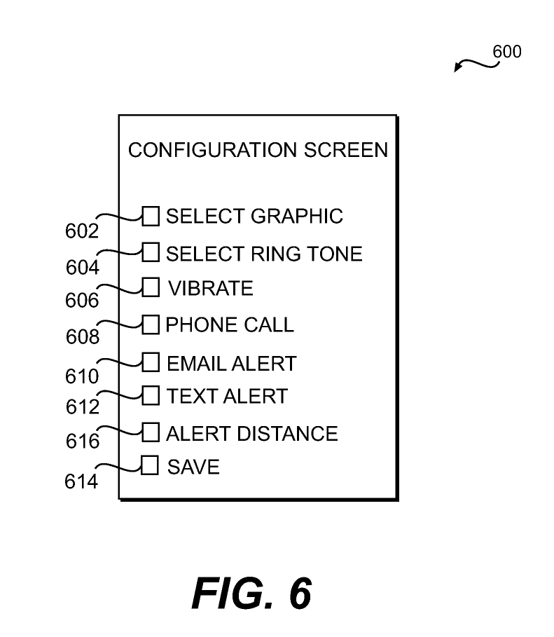

FIG. 6 illustrates configuration screen 600 that a user of Left-behind App 114 sees as a GUI on MED 124 when they tap Configuration Button 504 shown in FIG. 5 according to an embodiment. The configuration screen GUI 600 includes Select Graphic button 602, Select Ring Tone Button 604, Enable Vibrate Button 606, Phone Call Button 608, Email Alert Button 610, and Text Alert Button 612. Each will be discussed in turn.

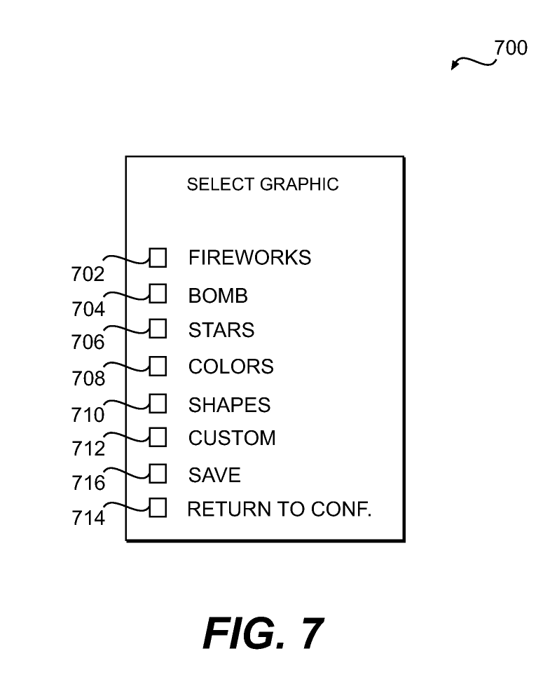

Select Graphic Button 602 provides a user selectable feature of setting which graphic to display on MED 124 when the alert sounds. When Select Graphic Button 602 is tapped by the user, then Graphic Configuration Screen 700 will open, as shown in FIG. 7 according to an embodiment. Buttons 702-712 will appear, showing small graphical displays of predefined graphic images that can be selected by the user as the graphic of choice to show when USB/ED/BT device 100 becomes lost, misplaced or missing. Buttons 714 and 716 also appear, and are discussed in detail below. As those of skill in the art can appreciate, the aspects of the embodiments are not limited to the several graphics shown in FIG. 7, and many others can be added or a user can select a custom image according to processes and methods that are known to those of skill in the art, and therefore do not need to be discussed in detail herein. Pressing Custom Button 712 allows a user to choose a graphic from their phone or tablet picture gallery. Once a graphic has been selected, it can become highlighted, or show some other indication of being selected, and the user can press Save Button 712 to save the selection and return to Configuration Screen 600, or press Return to Configuration Button 714 to not immediately save the selection (if one was made), and return to Configuration Screen 600, whereupon Configuration Screen 600 is displayed on MED 124, as shown in FIG. 6, and the user can save all of the previously selected settings, or just the new setting, by tapping or pressing Save Button 614. This then returns the user to Main Screen 500, upon which the user can minimize, or close Left-behind App 114, although, however, “closed” Left-behind App 114 is always running as a background application whenever MED 124 is powered on. According to an embodiment, even if the user closes Left-behind App 114 at any point, it continues to run as a background application and constantly monitors the appropriate frequencies (according to the communications' protocol being used, e.g., BT frequencies) for the registered and paired BT device. If one is detected, Left-behind App 114 will still notify the user in the event of a left-behind situation even though it is running as a background application.

Presuming that, for the purposes of this discussion, the user is engaging in an original setup process, and will at least go through all of the configuration choices possible. Thereupon, after downloading Left-behind App 114, the user wants to completely set up Left-behind App 114. Upon saving the selected graphics from either the predefined selection shown in FIG. 7, or a custom graphic, the user returns to Configuration Screen 600 by pressing Return-to-Configuration Button 714, whereupon the user can save the settings (or not, according to an embodiment) and presses Select Ring Tone Button 604. Those of skill in the art can appreciate that the order of selecting the various features can be done in any order, or not at all, or only some can be selected, and default values (or none) can be used in that latter case.

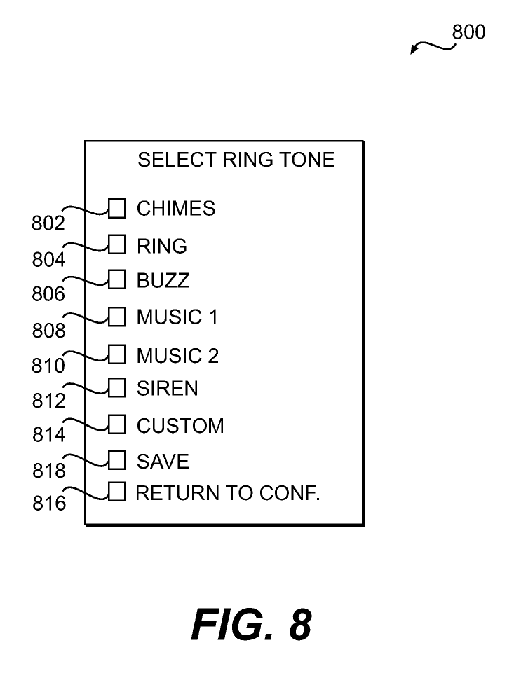

When the user taps Select Ring Tone Button 604, Select Ring Tone Screen 800 as shown in FIG. 8 will be displayed. The user can select from one of predefined ring tones 802-812, or select a custom ring tone by pressing Custom Button 814. Pressing Custom Button 814 allows the user to select from their phone or tablet ring tone library if applicable/available. As those of skill in the art can appreciate, mechanisms, processes and procedures are available that allow the user to sample the ring tone for a few seconds prior to making a decision as to which ring tone to select. In fulfillment of the dual purposes of clarity and brevity, these processes have been omitted as their functionality is known to those of skill in the art. Once a ring tone has been selected, it can become highlighted, or show some other indication of being selected, and the user can press Save Button 818 to save the selection and return to Configuration Screen 600, or press Return to Configuration Button 816 to not immediately save the selection (if one was made), and return to Configuration Screen 600, whereupon Configuration Screen 600 is displayed on MED 124, as shown in FIG. 6, and the user can save all of the previously selected settings, or just the new setting, by tapping or pressing Save Button 614 according to an embodiment.

Also shown in FIG. 6, as part of Configuration Screen 600, is Vibrate Button 606. If the vibrate function is selected by pressing or tapping Vibrate Button 606, MED 124 will vibrate to alert the user if so equipped, regardless of what tone has been selected, if any, or if the volume has been turned down to a zero setting. However, as known to those of skill in the art, certain MEDs 124 include a vibration cancel feature, especially in the case of cellular telephone devices, so that even that minor sound/sensation can be turned off to prevent inadvertent interruptions in certain situations.

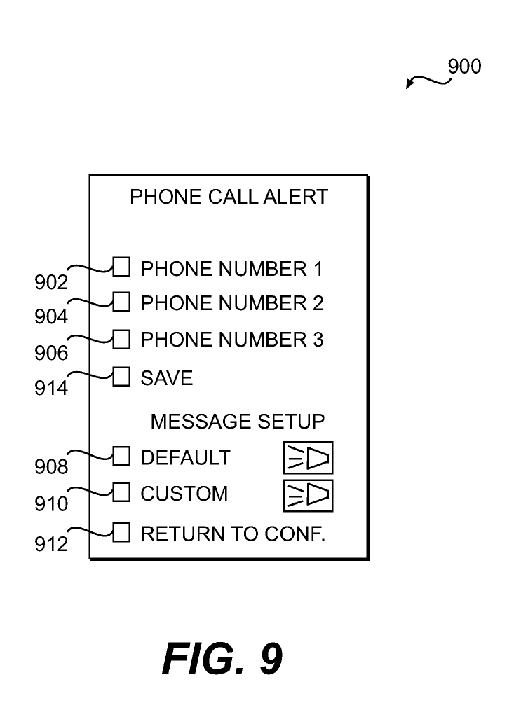

Another user selectable feature of Left-behind App 114 is the phone call feature. That is, when a user can chose to have a phone call made whenever an alert condition occurs. Thus, if the user taps Phone Call Button 608 on Configuration Screen 600, the user will be directed to Phone Call Alert Screen 900 as shown in FIG. 9. Once Left-behind App 114 has transferred the user to Phone Call Alert Screen 900, the user can select one of several different features to further update Left-behind App 114. That is, as shown on Phone Call Alert Screen 900, the user can enter one or more phone numbers for Left-behind App 114 to automatically call when the an USB alert occurs. According to a further embodiment, the user can also select either a default message (Default Button 908) to be played upon the phone alert, or can record a custom message (Custom Button 910), in a manner, that is known to those that have recorded messages on their home or business voicemail systems. As with the select ring tone feature (Select Ring Tone Button 604), the user can press the listen button to hear the message before and after recording and/or selection. Once all of the parameters have been selected for the phone call alert feature, the buttons or objects representing the alert features can become highlighted, or show some other indication of being selected, and the user can press Save Button 914 to save the selection and return to Configuration Screen 600, or press Return to Configuration Button 912 to not immediately save the selection (if one was made), and return to Configuration Screen 600, whereupon Configuration Screen 600 is displayed on MED 124, as shown in FIG. 6, and the user can save all of the previously selected settings, or just the new setting, by tapping or pressing Save Button 614 according to an embodiment.

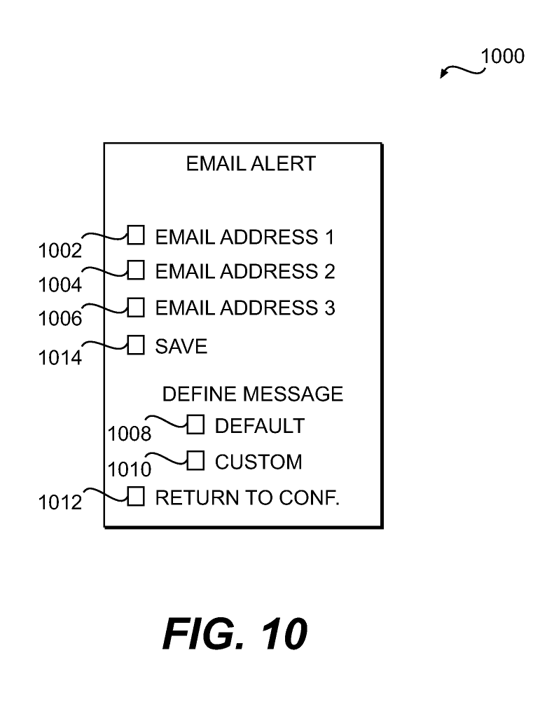

According to a further embodiment, the user can also have an email sent when the USB alert is triggered. Upon tapping Email Alert Button 610, the user is directed to Email Alert Screen 1000 as shown in FIG. 10. Similarly to Phone Call Alert Screen 900, the user is then prompted to enter one or more email addresses, using buttons 1002, 1004, and 1006. A default message can be generated by tapping Default Button 1008, or a custom message can be typed in by tapping Custom Button 1010, and entering the text accordingly. According to a further embodiment, the email message sent to the one or more email addresses as provided by the user can further include the geographical coordinates of the last known location of MED 124 when the left-behind condition first occurred and the alert was sent. Once the email addresses and message have been selected, their respective buttons or objects can become highlighted, or show some other indication of being selected, and the user can press Save Button 1014 to save the selection and return to Configuration Screen 600, or press Return to Configuration Button 1012 to not immediately save the selection (if one was made), and return to Configuration Screen 600, whereupon Configuration Screen 600 is displayed on MED 124, as shown in FIG. 6, and the user can save all of the previously selected settings, or just the new setting, by tapping or pressing Save Button 614 according to an embodiment.

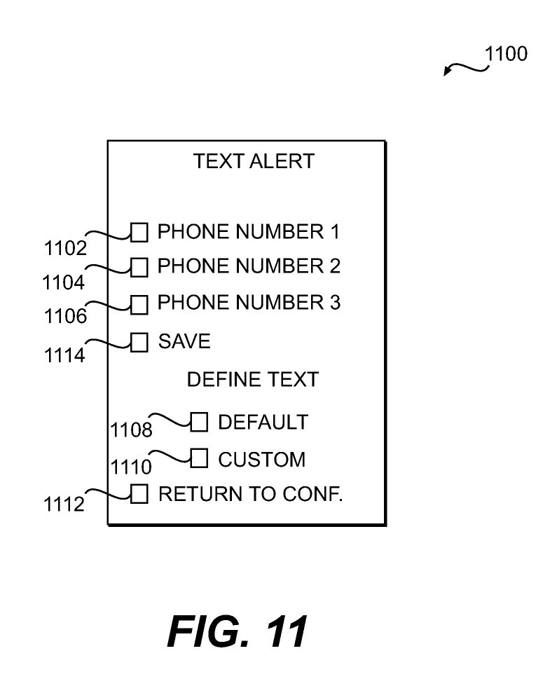

According to a further embodiment, the user can also have a text sent when the USB alert is triggered. Upon tapping Text Alert Button 612, the user is directed to Text Alert Screen 1100 as shown in FIG. 11. Similarly to Phone Call Alert Screen 900, or Email Alert Screen 1000, the user is then prompted to enter one or more text addresses (i.e., phone numbers), using buttons 1102, 1104, and 1106. A default message can be generated by tapping Default [text message] Button 1108, or a custom message can be typed in by tapping Custom [message] Button 1110, and entering the text accordingly. According to a further embodiment, the text message sent to the one or more email addresses as provided by the user can further include the geographical coordinates of the last known location of MED 124. Once the text message addresses and message have been selected, the respective button or object can become highlighted, or show some other indication of being selected, and the user can press Save Button 1114 to save the selection and return to Configuration Screen 600, or press Return to Configuration Button 1112 to not immediately save the selection (if one was made), and return to Configuration Screen 600, whereupon Configuration Screen 600 is displayed on MED 124, as shown in FIG. 6, and the user can save all of the previously selected settings, or just the new setting, by tapping or pressing Save Button 614 according to an embodiment.

According to a further embodiment, the user can also configure Left-behind App 114 to change a maximum alert distance; that is, the user can determine a percentage of the maximum alert distance to cause an alert to be triggered. As described above, the maximum alert distance is essentially determined by, in the case of BT transmission protocols, the class of BT device that USB/ED/BT device 100 is configured to be. Of course, as those of skill in the art can appreciate, device 100 is not solely limited to BT transmission protocols, so its maximum transmit distance can be different depending on the type of protocol being used (Wi-Fi, cellular, NFC, among others). For ease of discussion however, and not to be taken in a limiting manner, the following discussion will consider just BT class protocols, and in particular class 2, wherein the maximum transmission distance, without considering environmental interference concerns, is about 10 meters, or about 31 feet or so.

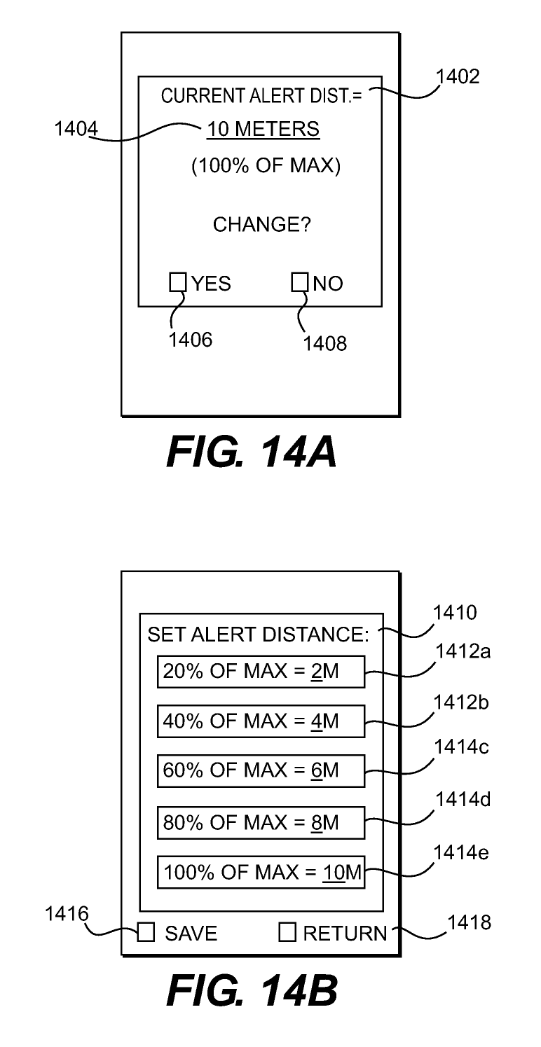

Thus, as shown in FIG. 6, if the user presses Alert Distance button 616, Current Alert Distance GUI 1402 is displayed, as shown in FIG. 14A. In maximum distance object 1404, “10 meters” is displayed (this of course could be set to standard units, and not metric) to alert the user that the current maximum distance for triggering an alert condition is the maximum for the particular transmission protocol in use, in this non-limited case, class 2 BT, which is about 10 meters. The user then is presented with the option of changing or not changing the current setting, and selects Yes button 1406 to change the maximum distance to trigger an alert condition, or selects No button 1408 to keep the maximum distance to trigger an alert condition the same as the current setting.

Presuming, however, that the user does press Yes button 1406, Set Alert Distance GUI 1410 as shown in FIG. 14B is displayed. As shown in FIG. 14B, the user in this case is presented with five gradations of maximum alert triggering distances objects 1412a through 1412e, which respectively correspond to 20%, 40%, 60%, 80%, and 100% of the maximum alert triggering distance. As those of skill in the art can appreciate, the five gradations is but just one non-limiting example, and other gradations are possible, e.g., 25%, 10%, or 5%, among others. The user can then select one, it can become highlighted, or show some other indication of being selected, and the user can press Save button 1416 to save the selection and return to Configuration Screen 600, or press Return button 1418 to not immediately save the selection (if one was made, and return to Configuration Screen 600, whereupon Configuration Screen 600 is displayed on MED 124, and the user can save all of the previously selected settings, or just the new setting, by tapping or pressing Save Button 614.

As those of skill in the art can appreciate, configuration of Left-behind App 114 on MED 124 generally does not take a long period of time, perhaps only a few minutes. Once all of the configuration screens have been processed, or if the user decides not setup anything, or only a couple of configurable items, the user can then select “Pair” representing or calling out the pairing function, as discussed above.

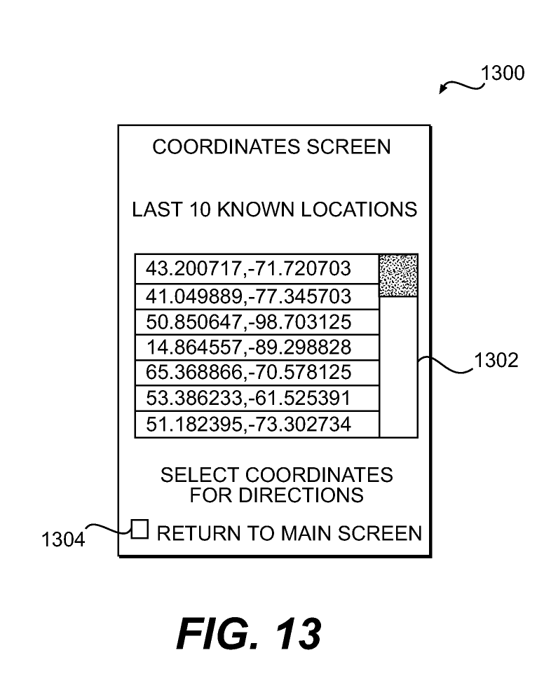

By tapping Pair Button 506 (shown in FIG. 5), the user enacts the pairing function. According to a further embodiment, upon downloading of Left-behind App 114 on MED 124, it will automatically begin searching for nearby USB devices, and the user can select the desired item. As those of skill in the art can appreciate, USB/ED/BT device 100 only needs to be paired once. After that Left-behind App 114 will know when USB/FD/BT device 100 has power and is within the controlled area (according to embodiments, about 10 meters). Pairing is the process wherein Left-behind App 114 on MED 124 learns the identity of USB/ED/BT device 100 (i.e., through a special BT code). Also, once Left-behind App 114 on MED 124 detects USB/ED/BT device 100, a record of the geographical coordinates will be logged; this is shown in FIG. 13. A user can also review the coordinates by tapping Coordinates Button 508 from screen 500 shown in FIG. 5 to get to Coordinates Screen 1300 according to embodiments.

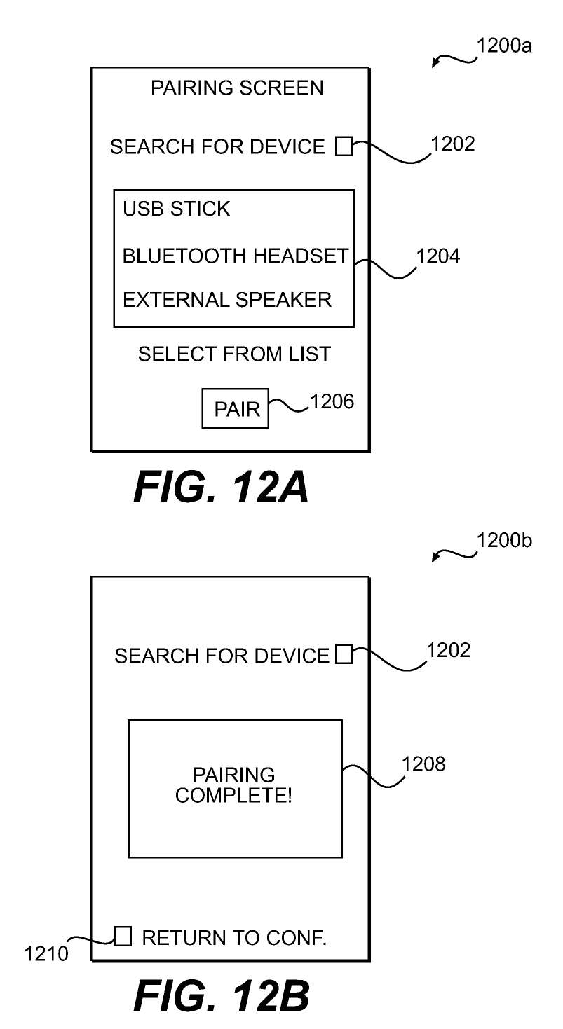

Referring now to FIG. 12A, and Pairing Screen 1200a, which is reached by tapping Pair Button 506, the user can tap Search for Devices Button 1202; GUI interface 1204 will appear, and the user can select the desired USB device to pair with electronic device 100 and Left-behind App 114 according to an embodiment. As discussed above, USB/ED/BT device 100 need not be a flash-drive memory type device, though that might be most common; the device that can be paired with Left-behind App 114 on MED 124 can also be a Bluetooth headset, or external speaker, among other items. The user can then select the desired device, and then tap Pair Button 1206. This causes Left-behind App 114 to sync-to the device (in this non-limiting example, USB/ED/BT device 100) to Left-behind App 114. Once synchronization or pairing has taken place, Pairing screen 1200b will be displayed on MED 124, and Pairing Complete graphical object 1208 will be displayed as shown in FIG. 12B. Another device can be searched for, by tapping Search for Device Button 1202 (again), or, the user can return to Configuration Screen 600 by tapping Return-to-Configuration Button 1210. The user can then tap Save Button 614, which saves the settings, including the pairing information, and returns the user to Left-behind App Main Screen 500.

As discussed above, the geographical coordinates of where USB/ED/BT device 100 was last used can be extremely useful when trying to track down USB/ED/BT device 100. However, Left-behind App 114 cannot tell exactly where USB/ED/BT device 100 was, but can tell where MED 124 was at the time of the alert. If, for some reason, the user does not hear the alert, or notice the vibration, and leaves USB/ED/BT device 100 behind, the user can access Left-behind App 114, and using the coordinates feature of Left-behind App 114, get the coordinates that can help locate USB/FD/BT device 100. Therefore, the user can tap Coordinates Button 508 once the user becomes aware that USB/ED/BT device 100 has become lost, and Coordinates Screen 1300 as shown in FIG. 13 will be displayed. Coordinates Screen 1300 will show a list of the last ten recorded locations of USB/ED/BT device 100 (actually the positions of MED 124) in Coordinates Displayed Object 1302. The user can select a set of coordinates (by tapping them) and Left-behind App 114 will automatically open a map program of MED 124 if so equipped. The map program, with data transferred to it from Left-behind App 114, will display the last known approximate location of USB/ED/BT device 100 and allow the user to get directions to that area to retrieve USB/ED/BT device 100. Then, the user can return to Main Screen 500 by pressing Return-to-Main Screen button 1304 whereupon Main Screen 500 is displayed on MED 124.

FIG. 15 illustrates a flowchart of a method of configuring and pairing USB/ED/BT device 100 with MED 124 according to embodiment. As those of skill in the art can appreciate, the order of steps performed in method 1500 are almost completely arbitrary; that is, no one step, other than downloading and opening Left-Behind App 114, needs to be performed before any other; however, in order to discuss the method, some step order has to be followed, and thus method 1500 as shown in FIG. 15 results. Nonetheless, those of skill in the art can appreciate that such depiction is non-limiting, and not meant to suggest in any way that any order of performance of the steps of method 1500 is implied or expressly asserted.

Method 1500 begins with step 1502 in which Left-behind App 114 is downloaded or obtained in some other manner and opened on MED 124. Left-behind App 114 is then opened and Main Screen 500 is displayed, as discussed in greater detail above. The user can then select Configuration Screen 600 in step 1504, and then in step 1506, selection of the alert graphic occurs. Of course, in addition to the order of steps being almost completely arbitrary it should also be appreciated that many of the steps are optional, and either have default values and/or characteristics, or Left-behind App 114 can operate completely normally with many of the steps shown in FIG. 15 not being performed. This is similar to currently available 4G/LTE so-called “smart phone” in which users sometimes take weeks or even months to figure out all of the features that they might be interested in; during the period of time from acquisition to enablement, the features either are dormant, or assume some default value.

Next, in method step 1508, the user can select a ring tone that audibly announces an alert that USB/ED/BT device 100 is possibly being left behind, lost, or misplaced. In step 1510, the user can enable a vibrate feature, if MED 124 is so equipped, to vibrate as an alert that USB/ED/BT device 100 is possibly being left behind, lost, or misplaced. In method step 1512, the user again has a choice as a possible alert feature; in this case, the user can set up a phone call notification as an alert that USB/ED/BT device 100 is possibly being left behind, lost, or misplaced. Method steps 1514 and 1516 are additional alert features. These two steps allow the user to set up email and text notifications in the event that USB/ED/BT device 100 is possibly being left behind, lost, or misplaced. As those of skill in the art can appreciate, and as discussed in greater detail above, following each method step 1506-1516, the user needs to also save the chosen configuration setting(s), and this can be done after each setting has been encountered and chosen, or it can be done after all possible choices have been made, or after some choices have been made. Finally, in method step 1518, the user can perform the pairing function, which as described above, pairs USB/ED/BT device 100 with MED 124 using Left-behind App 114 that is stored on MED 124, so that operation of method 200 according to an embodiment can occur.

FIG. 4 illustrates a functional block diagram of computer device 108 shown in FIG. 1. As briefly discussed above, computer device 108 is a device that USB/ED/BT device 100 is connected to, to execute some function, whether it be memory storage or access in the case of a flash drive, or conversation in the case of a BT enable headset, or music/voice generation if the case of a speaker. Thus, computer device 108 can be more than just a personal computer, laptop, or tablet; it can also be a digital stereo system that accepts music from flash drive device or plays songs that are heard from the BT enabled speaker set, among other items and function. In addition, in a broader sense, computer device 108 can also apply to MED 124. That is, in some cases, MED 124 can be a laptop or tablet, and so can include many if not all of the features shown in FIG. 4, and described below. Thus, those of skill in the art can appreciate that computer device 108 can in part apply to MED 124, or be the device to which is attached USB/ED/BT device 100.

In the discussion that followed, it will be appreciated by those skilled in the art that the use relative directional terms, if any, such as “vertical” and “horizontal” in the preceding discussion are primarily used to orient the reader relative to the examples provided in the illustrations, and that in an actual implementation of such embodiments, the information flows are defined by various paths which may or may not be properly characterized using directional or even geometrical terminology.

According to an embodiment, implementation of methods 200 and 1400 can occur in a dedicated processor shown in FIGS. 1 and 4 if such apparatus represents a particular MED 124. Those of ordinary skill in the art in the field of the embodiments can appreciate that the functionality of the processor(s) can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices. Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures.

Computer device 108 includes, among other items, internal data/communications bus (bus) 406, processor(s) 404 (those of ordinary skill in the art can appreciate that in modern server systems, parallel processing is becoming increasingly prevalent, and whereas a single processor would have been used in the past to implement many or at least several functions, it is more common currently to have a single dedicated processor for certain functions (e.g., digital signal processors) and therefore could be several processors, acting in serial and/or parallel, as required by the specific application), universal serial bus (USB) port 416, compact disk (CD)/digital video disk (DVD) read/write (R/W) drive 418, floppy diskette drive 420 (though less used currently, there are still many PCs that include this device), and data storage unit 408.

Data storage unit 408 itself can comprise hard disk drive (HDD) 410 (these can include conventional magnetic storage media, but, as is becoming increasingly more prevalent, can include flash drive-type mass storage devices, among other types), ROM device(s) 412 (these can include electrically erasable (EE) programmable ROM (EEPROM) devices, ultra-violet erasable PROM devices (UVPROMs), among other types), and random access memory (RAM) devices 414. Usable with USB port 416 is USB/FD/BT device 100 (and of course a simple FD device), and usable with CD/DVD R/W drive 418 are CD/DVD disks 430 (which can be both read and write-able). Usable with diskette drive 420 are floppy diskettes 428. Each of the memory storage devices, or the memory storage media (410, 412, 414, 100, 430, and 428, among other types), can contain parts or components of, or in its entirety, executable software programming code (software; Left-behind App 114 that can implement part or all of the portions of the method described herein in the event that computer device represents a particular kind of MED 124). Further, processor 404 itself can contain one or different types of memory storage devices (most probably, but not in a limiting manner, RAM memory storage media 414) that can store all or some of the components of Left-behind App 114.

In addition to the above described components, computer device 108 can also include external keyboard 434, external display 432 (while typically MED 124 can be a smart phone, or tablet, which would not typically have external devices connected to it, MED 124 can be a more conventional personal computer, laptop, or even tablet, all of which can or do have external components connected to them), and mouse 436 (which can also be wireless, as can also external keyboard 434, and external display 432). All of these components are known to those of ordinary skill in the art, and this description includes all known and future variants of these types of devices. Display 432 can be any type of known display or presentation screen, such as liquid crystal displays (LCDs), light emitting diode displays (LEDs), plasma displays, cathode ray tubes (CRTs), among others. One or more user interface mechanisms can also be present such as a microphone, touch pad, touch screen, voice-recognition system, among other inter-active inter-communicative devices. The display can also be a touch screen interface in the form of second display 442, and thus incorporates touch-screen keyboard 440.

Computer device 108 can access internet 438, either through a hard wired connection, via I/O interface 402 directly, or wirelessly via one or more of BT transceiver 120, near-field communication (NFC) antenna 424, and Wi-Fi/wireless antenna 426. Computer device 108 can be coupled to other computing devices, via one or more networks. Computer device 108 can be part of a larger network configuration as in a global area network (GAN) (e.g., internet 438), which ultimately allows connection to various landlines.

Computer device 108, in the form of MED 124, can be used to implement method 200 for preventing the loss of USB/ED/BT device 100 according to an embodiment. Hardware, firmware, software or a combination thereof may be used to perform the various steps and operations described herein. According to an embodiment, Left-behind App 114 for carrying out the above discussed steps can be stored and distributed on multi-media storage devices such as devices 410, 412, 414, 100, 430, and/or 428 (described above) or other form of media capable of portably storing information. These storage media may be inserted into, and read by, devices such as the CD-ROM drive 418, disk drives 410, 429, among other types of software storage devices.

As also will be appreciated by one skilled in the art, the various functional aspects of the embodiments may be embodied in a wireless communication device, a telecommunication network, as a method, or in a computer program product. Accordingly, the embodiments may take the form of an entirely hardware embodiment or an embodiment combining hardware and software aspects. Further, the embodiments may take the form of a computer program product stored on a computer-readable storage medium having computer-readable instructions embodied in the medium. Any suitable computer-readable medium may be utilized, including hard disks, CD-ROMs, digital versatile discs (DVDs), optical storage devices, or magnetic storage devices such a floppy disk or magnetic tape. Other non-limiting examples of computer-readable media include flash-type memories or other known types of memories.

Further, those of ordinary skill in the art in the field of the embodiments can appreciate that such functionality can be designed into various types of circuitry, including, but not limited to field programmable gate array structures (FPGAs), application specific integrated circuitry (ASICs), microprocessor based systems, among other types. A detailed discussion of the various types of physical circuit implementations does not substantively aid in an understanding of the embodiments, and as such has been omitted for the dual purposes of brevity and clarity. However, as well known to those of ordinary skill in the art, the systems and methods discussed herein can be implemented as discussed, and can further include programmable devices.

Such programmable devices and/or other types of circuitry as previously discussed can include a processing unit, a system memory, and a system bus that couples various system components including the system memory to the processing unit. The system bus can be any of several types of bus structures including a memory bus or memory controller, a peripheral bus, and a local bus using any of a variety of bus architectures. Furthermore, various types of computer readable media can be used to store programmable instructions. Computer readable media can be any available media that can be accessed by the processing unit. By way of example, and not limitation, computer readable media can comprise computer storage media and communication media. Computer storage media includes volatile and non-volatile as well as removable and non-removable media implemented in any method or technology for storage of information such as computer readable instructions, data structures, program modules or other data. Computer storage media includes, but is not limited to, RAM, ROM, EEPROM, flash memory or other memory technology, CDROM, digital versatile disks (DVD) or other optical disk storage, magnetic cassettes, magnetic tape, magnetic disk storage or other magnetic storage devices, or any other medium which can be used to store the desired information and which can be accessed by the processing unit. Communication media can embody computer readable instructions, data structures, program modules or other data in a modulated data signal such as a carrier wave or other transport mechanism and can include any suitable information delivery media.

The system memory can include computer storage media in the form of volatile and/or non-volatile memory such as read only memory (ROM) and/or random access memory (RAM). A basic input/output system (BIOS), containing the basic routines that help to transfer information between elements connected to and between the processor, such as during start-up, can be stored in memory. The memory can also contain data and/or program modules that are immediately accessible to and/or presently being operated on by the processing unit. By way of non-limiting example, the memory can also include an operating system, application programs, other program modules, and program data.

The processor can also include other removable/non-removable and volatile/non-volatile computer storage media. For example, the processor can access a hard disk drive that reads from or writes to non-removable, non-volatile magnetic media, a magnetic disk drive that reads from or writes to a removable, non-volatile magnetic disk, and/or an optical disk drive that reads from or writes to a removable, non-volatile optical disk, such as a CD-ROM or other optical media. Other removable/non-removable, volatile/non-volatile computer storage media that can be used in the operating environment include, but are not limited to, magnetic tape cassettes, flash memory cards, digital versatile disks, digital video tape, solid state RAM, solid state ROM and the like. A hard disk drive can be connected to the system bus through a non-removable memory interface such as an interface, and a magnetic disk drive or optical disk drive can be connected to the system bus by a removable memory interface, such as an interface.

The embodiments discussed herein can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs and generally optical data storage devices, magnetic tapes, flash drives, and floppy disks. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to, when implemented in suitable electronic hardware, accomplish or support exercising certain elements of the appended claims can be readily construed by programmers skilled in the art to which the embodiments pertains.

The disclosed embodiments provide hardware, firmware, computer software, and a method for preventing the loss of USB/ED/BT device 100. It should be understood that this description is not intended to limit the embodiments. On the contrary, the embodiments are intended to cover alternatives, modifications, and equivalents, which are included in the spirit and scope of the embodiments as defined by the appended claims. Further, in the detailed description of the embodiments, numerous specific details are set forth to provide a comprehensive understanding of the claimed embodiments. However, one skilled in the art would understand that various embodiments may be practiced without such specific details.

Reference throughout the specification to “one embodiment” or “an embodiment” means that a particular feature, structure, or characteristic described in connection with an embodiment is included in at least one embodiment of the embodiments. Thus, the appearance of the phrases “in one embodiment” on “in an embodiment” in various places throughout the specification is not necessarily referring to the same embodiment. Further, the particular feature, structures, or characteristics may be combined in any suitable manner in one or more embodiments.

Although the features and elements of the embodiments are described in the embodiments in particular combinations, each feature or element can be used alone, without the other features and elements of the embodiments, or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

The above-described embodiments are intended to be illustrative in all respects, rather than restrictive, of the embodiments. Thus the embodiments are capable of many variations in detailed implementation that can be derived from the description contained herein by a person skilled in the art. No element, act, or instruction used in the description of the present application should be construed as critical or essential to the embodiments unless explicitly described as such. Also, as used herein, the article “a” is intended to include one or more items.

All United States patents and applications, foreign patents, and publications discussed above are hereby incorporated herein by reference in their entireties.

I claim:

1. A method for substantially preventing the loss of a first electronic device comprising:
establishing short distance wireless communications between the first electronic device and a second electronic device according to a first wireless communications protocol;
monitoring a signal level strength of the first wireless communication signals between the first electronic device and the second electronic device; and
providing an alert when the signal level strength of the first wireless communication signals falls below a first predetermined short distance communications signal level strength threshold.

2. The method according to claim 1, wherein the step of establishing first wireless communications comprises:
downloading a first device position monitoring application on the second electronic device; and
configuring the first device position monitoring application on the second electronic device to recognize the first electronic device according to the first wireless communications protocols.

3. The method according to claim 2, wherein the step of configuring comprises:
using as the first wireless communications protocol a Bluetooth (BT) wireless communications protocol; and
performing a pairing procedure between the first electronic device and the second electronic device according to BT pairing procedures.

4. The method according to claim 2, wherein the step of configuring comprises:
selecting an alert procedure to inform a user of the second electronic device when the signal level strength of the short distance wireless communication signal falls below the first predetermined short distance communications signal level strength threshold.

5. The method according to claim 4, wherein the step of selecting an alert procedure comprises:
selecting one or more of an alert graphic, an alert audible tone, enablement of a vibration to occur, a phone call notification, an email notification, and a texting notification.

6. The method according to claim 1, wherein the step of monitoring comprises:
comparing the signal level strength of a received first wireless communication signal with a first predetermined signal level strength threshold, such that when the received signal level strength of the first wireless communication signals falls below the first predetermined signal level strength threshold, that a position condition of the first electronic device relative to the second electronic device has changed from a normal condition to a left-behind condition.

7. The method according to claim 6, wherein the left-behind condition comprises:
a first percentage of a maximum distance of communications when using the first wireless communications protocols, and wherein the first percentage of the maximum distance can be any percentage between about 0% to about 100% of the maximum distance of communications when using the first wireless communications protocol.

8. The method according to claim 7, wherein
the first wireless communications protocol is a Bluetooth (BT) wireless communication system protocol, and the maximum distance is based on a class classification of the first electronic device.

9. The method according to claim 8, wherein the first device is a universal serial bus (USB) flash drive (FD) memory storage device with a BT transceiver, and further wherein the BT transceiver receives its power from a USB power connection.

10. The method according to claim 9, wherein the first device can be one of a BT enabled speaker apparatus, and headset.

11. A system for substantially preventing the loss of a first electronic device, wherein the first electronic device includes a first wireless communications transceiver, the system comprising:
a second electronic device that includes a processor, memory, and a first wireless communications transceiver, and wherein
the second electronic device is configured to communicate with the first electronic device according to a first wireless communications protocol, and wherein
the second electronic device is further configured to monitor a signal level strength of the first wireless communication signals from the first electronic device, and further wherein the second electronic is configured to provide an alert when the signal strength of the first wireless communication signals falls below a first predetermined short distance communications signal level strength threshold.

12. The system according to claim 11, wherein the first wireless communications protocol is one of a Bluetooth, near field communications and Wi-Fi communications protocol.

13. The system according to claim 11, wherein
the second electronic device has stored in a memory therein a first device position monitoring application and further wherein
the first device position monitoring application on the second electronic device is configured to recognize the first electronic device according to the first wireless communications protocols.

14. The system according to claim 13, wherein the first electronic device comprises:
a Bluetooth (BT) communications transceiver powered by interconnection with a third electronic device, and wherein the interconnection is a universal serial bus interconnection (USB), and wherein
the first wireless communications protocols is a Bluetooth communications protocol, and the second device is configured to perform a pairing procedure between the first electronic device and the second electronic device according to Bluetooth pairing procedures.

15. The system according to claim 14, wherein
the first device position monitoring application is configured to generate an alert to inform a user of the first and second electronic device when the signal level strength of the short distance wireless communication signal falls below the first predetermined short distance communications signal level strength threshold.

16. The system according to claim 15, wherein the alert in the second electronic device comprises:
one or more of a graphic, audible tone, vibration, phone call notification, email notification, and texting notification.

17. The system according to claim 11, wherein
the second electronic device is configured to compare the signal level strength of a received first wireless communication signal with a first predetermined signal level strength threshold, such that when the received signal level strength of the first wireless communication signal falls below the first predetermined signal level strength threshold, that a position condition of the first electronic device relative to the second electronic device has changed from a normal condition to a left-behind condition.

18. The system according to claim 17, wherein the left-behind condition comprises:
a first percentage of a maximum distance of communications when using the first wireless communications protocols.

19. The system according to claim 18, wherein
the first distance wireless communications protocol is a Bluetooth (BT) wireless communication system protocol, and the maximum distance is based on a classification of the first electronic device, and wherein the first percentage can be any percentage between about 0% to about 100% of the maximum distance of communications when using the BT wireless communication system protocol according to the classification of the first electronic device.

20. The system according to claim 19, wherein the first device is a universal serial bus (USB) flash drive (FD) memory storage device with a BT transceiver, and further wherein the BT transceiver receives its power from a USB power connection.

21. The system according to claim 19, wherein the first device can be one of a BT enabled speaker apparatus, and a headset.
